(19) United States
(12) Patent Application Publication
(10) Pub. No.: US 2005/0256780 A1
(43) Pub. Date: Nov. 17, 2005

(54) Electronically implemented vehicle marketing services

(75) Inventor: Cameron Eldred, Hanover, NH (US)

Correspondence Address: WILMER CUTLER PICKERING HALE AND DORR LLP, 60 STATE STREET, BOSTON, MA, 02109, US

(73) Assignee: Wired Logic, Inc., West Lebanon, NH (US)

(21) Appl. No.: 10/846,961

(22) Filed: May 14, 2004

(51) Int. Cl. G06F 17/60

(52) U.S. Cl. 705/26

(57) ABSTRACT

A computer-implemented method involving btaining used car inventory and sales history data from a dealer; obtaining from an auction house a list of auction cars that are being made available through an upcoming auction by the auction house; analyzing the dealer's used car inventory and sales data to identify one or more categories of cars that are under-stocked; identifying cars on the list of auction cars that are in the one or more identified categories of under-stocked cars; and generating a solicitation addressed to the dealer, the solicitation reporting the identified one or more categories of under-stocked cars and reporting the identified cars on the list of auction cars, the solicitation also seeking the dealer's participation in the upcoming auction.

### TECHNICAL FIELD

This invention relates to vehicle inventory management systems.

### BACKGROUND OF THE INVENTION

New car dealers frequently take in trade-ins from customers who are purchasing new cars or upgrading to a newer used car. Other dealers who deal strictly in used cars frequently add to their inventories of used cars by purchasing cars wholesale from new car dealers or from other businesses, such as fleet owners, that have used cars that they want to liquidate but they do not want to be in the business of selling used cars to the public. The profitability of the used cars to the used card dealers depends strongly on how quickly they can turn over their inventories. The longer that a car stays on the dealer's lot, the more that car ultimately costs the dealer. As a consequence, various market mechanisms have developed to improve the efficiency of the process of selling or liquidating inventories of used cars. One mechanism is the third party auction house. The auction house operates by scheduling auctions in which large numbers of used cars are put up for auction to participating parties and businesses. To participate in such auctions, the dealer must register his cars with the auction house and then arrange to have the cards delivered to the auction site. The participating dealers can also purchase cars at those auctions to fill a hole in their own inventories. The more efficient that such mechanisms operate, the more profitable it is for the used car market.

### SUMMARY OF THE INVENTION

In general, in one aspect, the invention features a computer-implemented method. The computer-implemented method involves: obtaining used car inventory and sales history data from a dealer; obtaining from an auction house a list of auction cars that are being made available through an upcoming auction by the auction house; analyzing the dealer's used car inventory and sales data to identify one or more categories of cars that are under-stocked; identifying cars on the list of auction cars that are in the one or more identified categories of under-stocked cars; and generating a solicitation addressed to the dealer, the solicitation reporting the identified one or more categories of under-stocked cars and reporting the identified cars on the list of auction cars, said solicitation also seeking the dealer's participation in the upcoming auction.

In general, in another aspect the invention features another computer-implemented method. The other computer-implemented method involves: obtaining used car inventory and sales history data from a dealer; analyzing the dealer's used car inventory and sales data to identify one or more categories of cars that are overstocked; generating a solicitation addressed to the dealer, the solicitation reporting the identified one or more categories of overstocked cars and seeking the dealer's participation in an upcoming auction.

Other embodiments include one or more of the following features. The computer-implemented method also includes sending the solicitation to the dealer. Obtaining used car inventory and sales history data from a dealer involves electronically polling a dealer inventory management system for that data.

In general, in yet another aspect the invention features a method implemented by a facilitator entity for soliciting participation by a used car dealer entity in an upcoming car auction being held by an auction house, the facilitator entity and the dealer entity being separate independent businesses. The method involves: obtaining electronically from the car dealer used car inventory and sales history data for cars held by that dealer; obtaining electronically from the auction house a list of auction cars that are being made available through an upcoming auction; causing a computer system to analyze the dealer's used car inventory and sales data to identify a category of cars that is under-stocked by that dealer; causing the computer system to identify cars on the list of auction cars that are in the under-stocked category; and generating a solicitation addressed to the dealer, the solicitation identifying the dealer's under-stocked category and identifying the cars on the list of auction cars that are in the under-stocked category.

In some of the embodiments, the facilitator entity and the auction house are separate independent business entities.

In general, in still yet another aspect, the invention features still another computer-implemented method. The computer-implemented method involves: obtaining electronically data regarding a car dealer's inventory of used cars, the inventory data including year, make, model, and mileage for each car represented in the inventory; generating a graphical user interface on a computer operated by a user on behalf of the car dealer, the graphical user interface listing used cars within the used car dealer's inventory of used cars, each displayed used car listing including a selection box for enabling a user selecting the vehicle to register with an auction house for auction; receiving an indication that the user has checked a box for a selected used car among the listing; in response receiving that indication, requesting confirmation that the user wants the selected used car to be registered with the auction house for an upcoming; in response to receiving confirmation from the user, registering the selected with the auction house.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a block diagram of the architecture of the DealerWire system.

FIG. 2 is a table of the data that is captured and stored by the data retrieval process.

FIG. 3 is a table of the data that is polled from the dealers for current vehicles in stock.

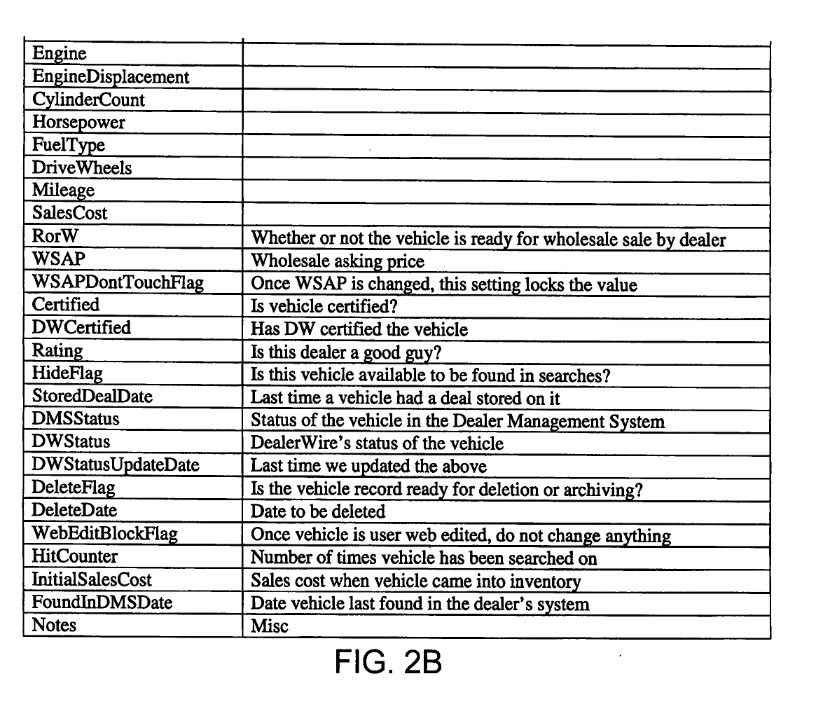

FIG. 4 is a table of the data that is polled from the dealers for sold vehicles.

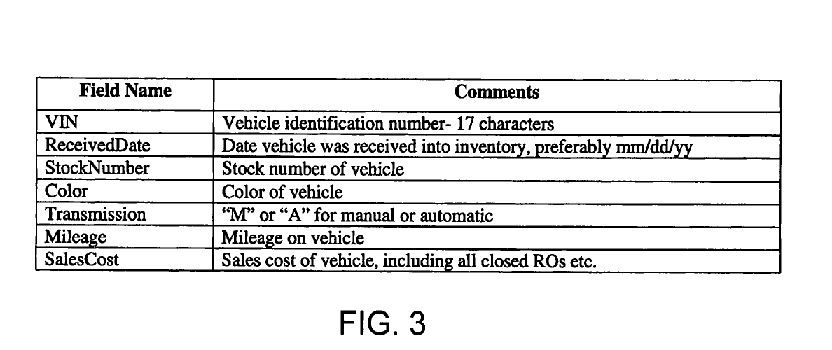

FIG. 5 is a table of the data that is polled from the dealers for deals that are worked but not sold.

FIG. 6 shows a screen shot of the home page.

FIG. 7 shows a screen shot of the page for Used Car Inventory.

FIG. 8 shows a screen shot of the page for Book Values.

FIG. 9 shows a screen shot of the page for Inventory Summary.

FIG. 10 shows a screen shot of the page for Inventory Analysis by Model.

FIG. 11 shows a screen shot of the page for Inventory Analysis by Market Class.

FIG. 12 shows a screen shot of the page for Selected Sales History—Retail.

FIG. 13 shows a screen shot of the page for Selected Sales Statistics.

FIG. 14 shows a screen shot of the page for Vehicle Details.

FIG. 15 shows a screen shot of the page for Vehicle to Auction.

FIG. 16 is an example of a communication identifying under-stocked units.

FIG. 17 is an example of a communication showing vehicles that match a dealer's needs.

FIG. 18 is an example of a communication showing dealer inventory models that have been in inventory for a while.

FIG. 19 is an example of an Inventory Alert.

### DETAILED DESCRIPTION

Description of System Architecture:

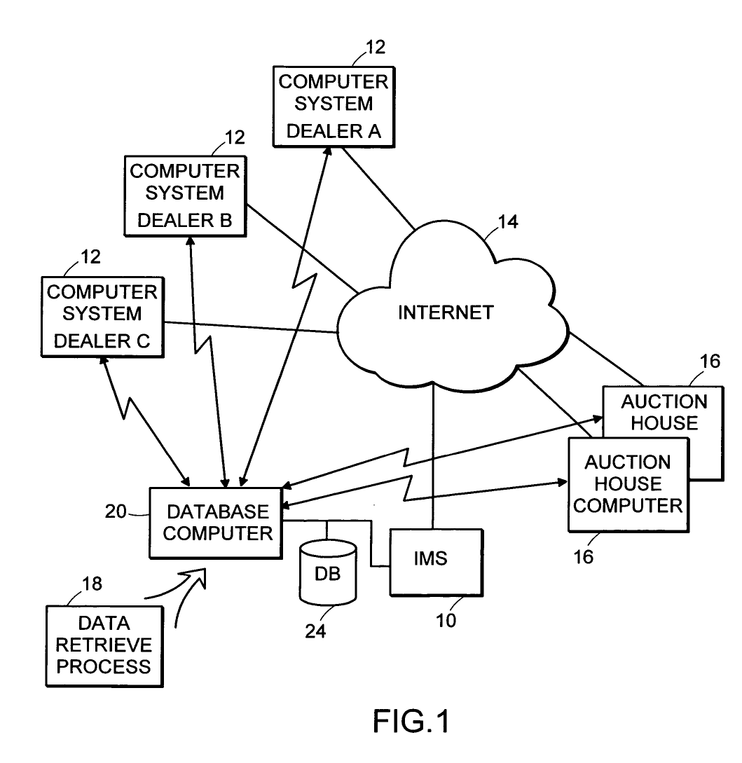

Referring to FIG. 1, at the heart of the overall system is a DealerWire Inventory Management System (IMS) 10 which provides various online services and tools to a network of computers 12 that are able to communicate with IMS 10 over the Internet 14. Computers 12 are physically located at the sites of used car and new car dealers who have signed up as members of a group to which DealerWire provides the various online tools and services. The group of dealers includes both independent and affiliated dealers. The services and tools are accessible to the users of computers 12 through a browser interface that runs on computers 12.

Through another group of computers 16, IMS 10 also provides other services to another category of users that includes independent auction houses, such as Manheim. In general, the auction houses provide auction services to dealers and other entities that want to use the auction mechanism as a way of selling vehicles. Parties who want to auction their vehicles through an auction house register their vehicles with the auction house and then make arrangements to transport the registered vehicles to the physical location of the auction prior to the date of the actual auction.

IMS 10 is connected a data storage system that stores a database of all of the sales, inventory and other information that DealerWire periodically collects from the group of dealers and it also stores data that is periodically collected from the participating auction houses. A data retrieval process 18 running on a separate data collecting computer 20 periodically communicates over private communication channels with each of the computers 12 at the dealer sites and each of the computers 16 at the auction houses and other third party sites to download all relevant data and information that is need to support the services that DealerWire provides to its members and participating auction houses. The computers at the auction houses also have the ability to push their data to data collecting computer 20 when data is available. Data collecting computer 20 takes the downloaded and received data and populates various tables that are maintained in database stored in a data storage system 24.

Through its IMS 10 and using the data collected and stored in its database, DealerWire provides the following set of services and tools to its member and the participating auction houses:
(1) enable users to analyze their new car inventories (e.g. inventory, sales) from all manufacturers using one interface.
(2) provide a cross manufacturer “locator tool” designed for new and used car dealer use.
(3) enable new vehicle inventory to be compared with sales history and enabling the time period to be manipulated by the user.
(4) provide dealers with aggregated used vehicle wholesale sales data (e.g. vehicle information, date of sale) from both auction sales and sales through other channels (e.g. wholesalers, on-line wholesale).
(5) enable dealers to identify other dealers based on current inventory shortage or excess of specific new or used car models.
(6) match individual dealer inventory status (based on user defined criteria) with inventory availability at a wholesale source (auction, manufacturer re-marketing department).
   Dealer Data Capture, Reformulation and Presentation:

Data retrieval process 18 takes data from different computer systems servicing different franchises and dealers and organizes it into a consistent database that can be used by all dealers. The views of the data through the user's browser are tailored depending on what data is being viewed and depending on whose data it is. So, for example, a dealer can see all of its information but can only see a limited portion of the information of other dealers.

IMS 10 enables the dealer members to perform customized analysis and queries on their data. The tools and the results are presented on the website for use by dealership personnel to make more intelligent wholesale inventory buying and selling decisions.

Data retrieval process 18 polls member inventory and sales history data nightly by connecting to the various dealership computer systems via a dial-up modem. It automatically retrieves, cleanses, organizes, and deposits the data into the database.

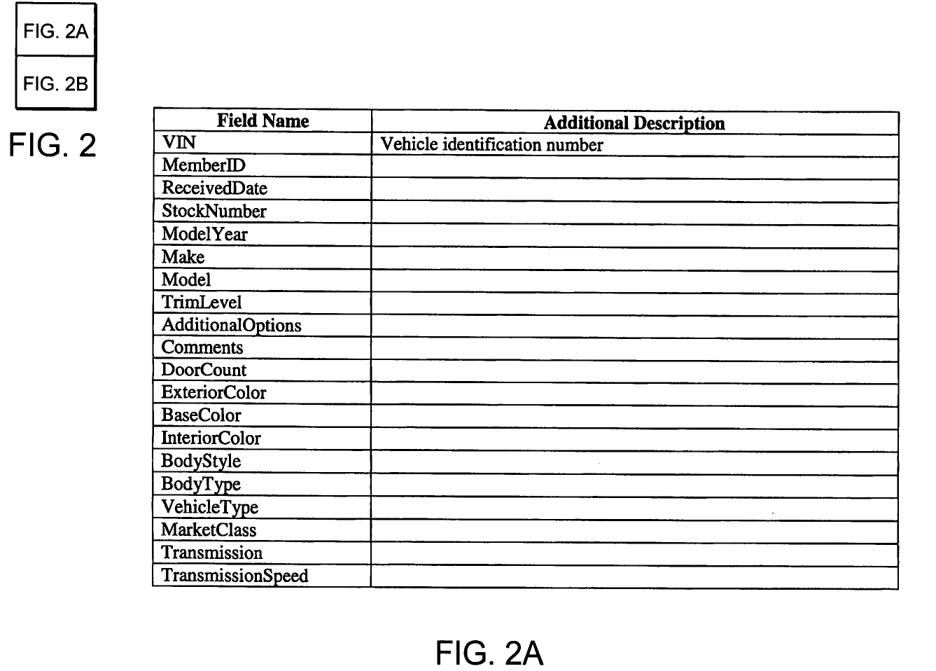

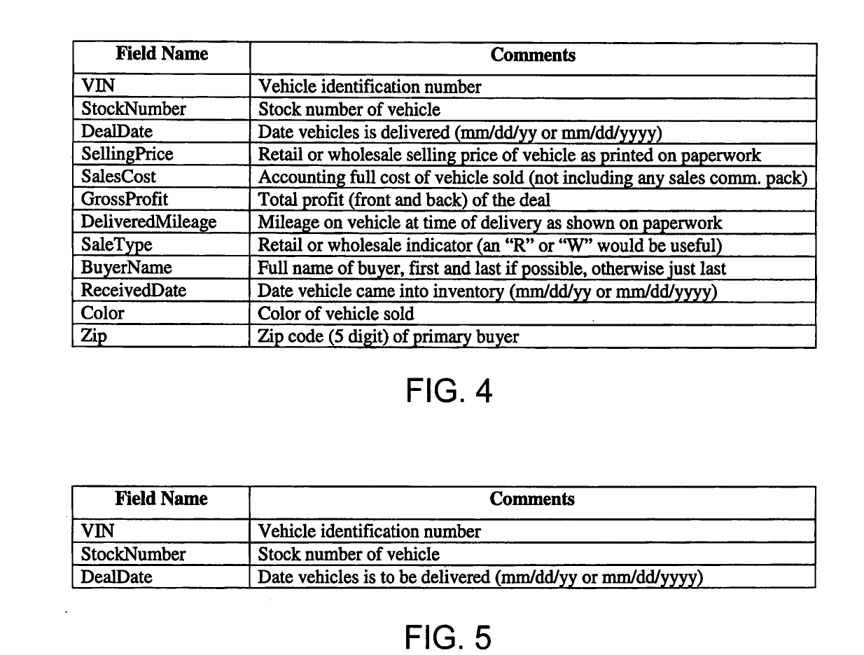

In general, for each vehicle, data retrieval process 18 captures and stores in its database data for the data fields shown in FIG. 2. The data that is polled from the dealers for current vehicles in stock is identified by the data fields shown in the table in FIG. 2. The information that is polled from the dealers for sold vehicles is identified by the data fields shown in FIG. 2. And the information that is polled from the dealers for stored deal information (i.e., about deals worked but not sold) is identified by the data fields shown in FIG. 5.

Data retrieval process 18 pulls sales history for the preceding one-year period at initial set up. Then, as time passes it archives months that are older than twelve months. The GUI-based interface makes available data for the previous twelve months of activity. IMS 10 can run reports on history older than one year.

Through this data retrieval process, vehicle inventory information is organized and stored on the DealerWire system. Thus, members will be able to manage their vehicle inventories online. Members can search for vehicles available for sale in other members' inventories through the IMS system and will be able to view information about the owner of that vehicle. Also, members will be able to view analysis performed on their own vehicles. This analysis will help dealers make informed inventory management decisions.

Basic Description of Software/Real Time Inventory Lists:

Members access inventory management, control, and analysis tools through a password protected website. Members use inventory management, control, and analysis tools available through IMS 10 to obtain a real time (e.g. updated nightly) list of all vehicles in inventory and to determine optimal inventory stocking objectives based on user defined criteria. Further, members analyze their current inventory positions and determine how they compare to the objectives, and members view specific wholesale buying and selling actions required to achieve the optimal inventory mix.

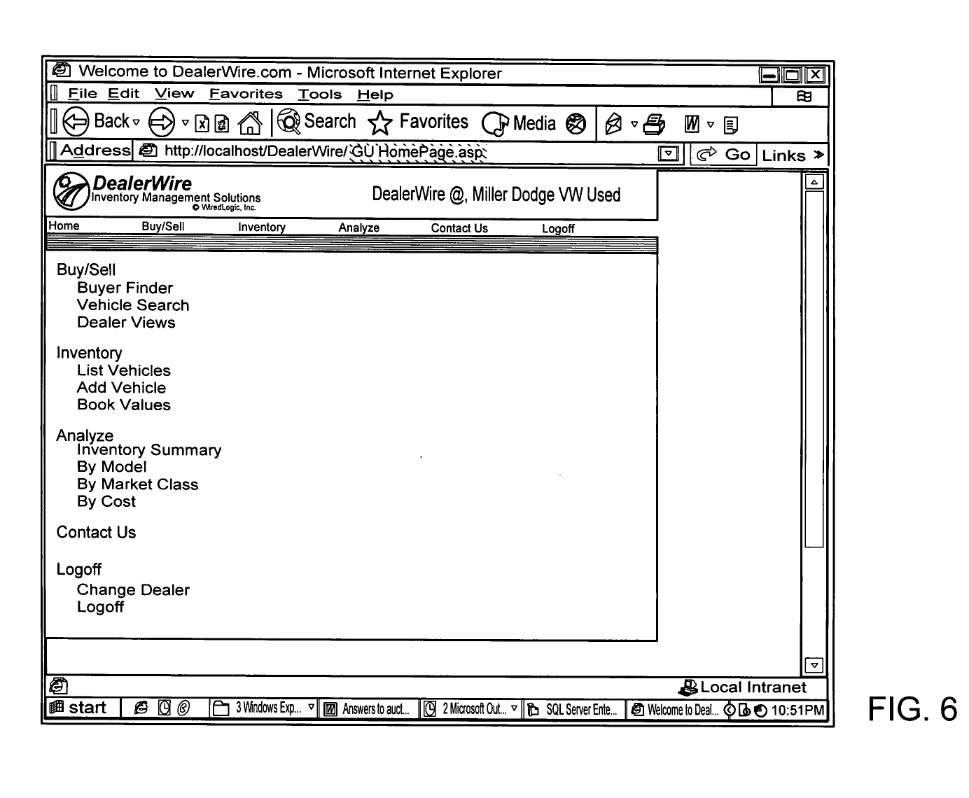

All users who are successfully logged on to the system can navigate within the IMS application from the homepage (see FIG. 6) or through the navigation menu (toolbar). The navigation menu has links to all the pages within the system, including Homepage, Vehicle Locator pages, Manage Inventory pages, Inventory Analysis pages, Contact page, and a logoff link that logs the user off and takes the user back to a Welcome page. When the user is in the homepage, he/she can use the links on the homepage or the navigation menu to go to other pages within the system. These two navigation methods are the means to get to all main pages that provide the functionality of the system.

The home page of the GUI that is presented to the user through the browser is shown in FIG. 6. It enables the user to select the various functions that are shown in the figure. Each of those functions will now be briefly described.

In the Buy/Sell category, the user can select the Buyer Finder function, the Vehicle Search function, or the Dealer Views function. Selecting the Buyer Finder function brings up a screen that enables the users to search for other members who are currently under-stocked in specific models. The “Buyer Finder” technology displays a list of members sorted by the dealership that is the most units under-stocked in a particular model (e.g. based on a trailing six month sales rate and a 60 day target inventory). Selecting the Vehicle Search function brings up a screen through which the user can search for vehicles in other members' inventories, or in the inventories of upcoming auctions by third parties, to fulfill inventory needs. And selecting the Dealer Views function brings up a screen through which users can access a list of all other members who have viewed their inventory on the site after performing a vehicle search. This enables willing wholesale sellers to actively contact other members who have revealed their interest in particular vehicles by searching.

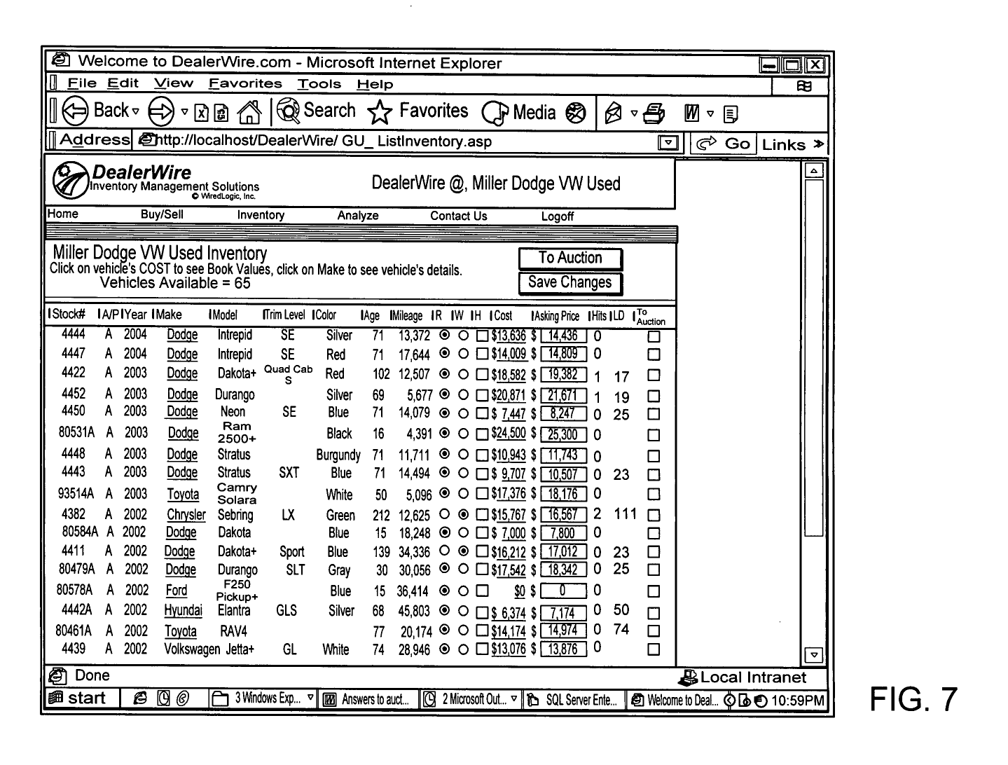

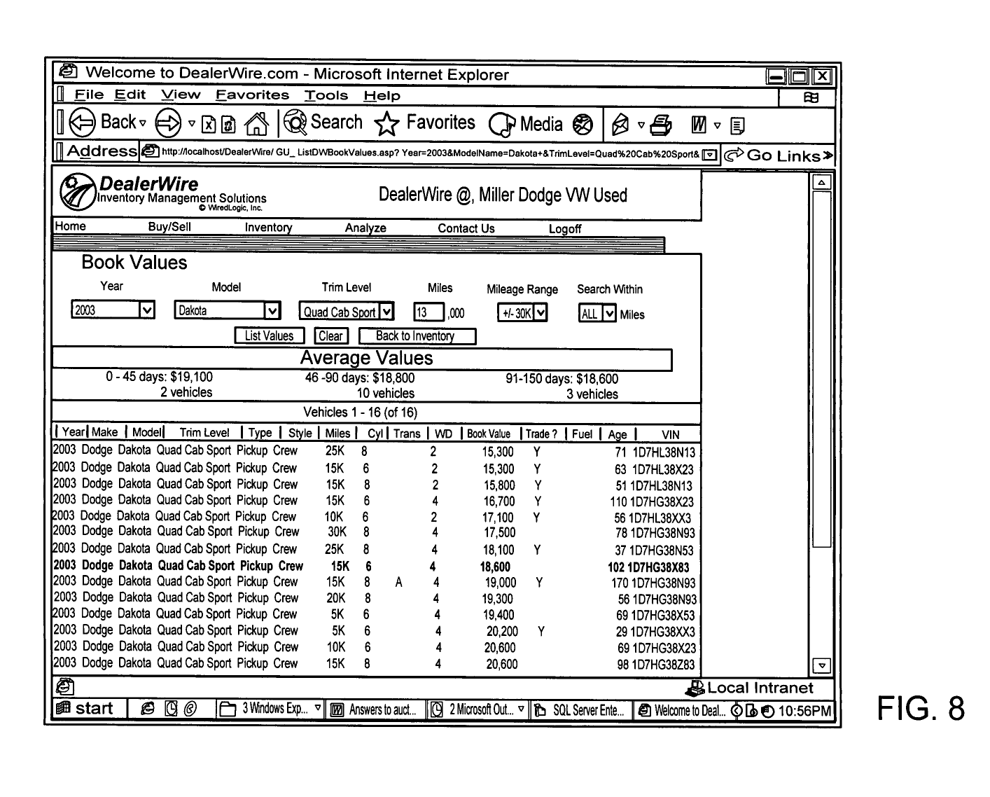

In the Inventory category, the user can select the List Vehicles function, the Add Vehicle function, or the Book Values function. Selecting the List Vehicles function enables the user to specify whether new or used is to be displayed. If used is selected, the IMS application will display a list of the used vehicles that are currently in the dealer's inventory. An example of such a list is shown in FIG. 7. Selecting the Add Vehicle function enables the user to manually add a vehicle to the list. Selecting Book Values brings up the screen shown in FIG. 8. This screen enables the user to specify the used cars in the DealerWire inventory for which he wants a list of book values. Through this screen, the user is able to specify year, model, trim level, mileage range, and distance from the dealer (i.e., the user).

The inventory-related functionality of IMS 10 falls into three distinct categories: Inventory Buy/Sell Facilitation, Inventory Control and Valuation, and Inventory Analysis. With regard to Inventory Buy/Sell Facilitation, the IMS application enables member dealers to search for, and trade, vehicles with one another at lower transaction costs than are typically achievable at live auctions. The IMS application offers intelligent trading recommendations that provide mutually advantageous economic value for the members on both sides of the transaction. With regard to Inventory Control and Valuation, the IMS application provides an accurate and flexible inventory tracking tool and provides accurate and timely vehicle appraisal and valuation service. The technology provides asset valuations that reflect prices from accounting book values updated daily. And with regard to Inventory Analysis, the IMS application provides inventory analysis tools for used cars that are updated daily to provide reliable asset management recommendations. Furthermore, it provides tools that enable dealers to perform sensitivity analysis by easily manipulating days supply targets and sales history date ranges.

Available Functionality:

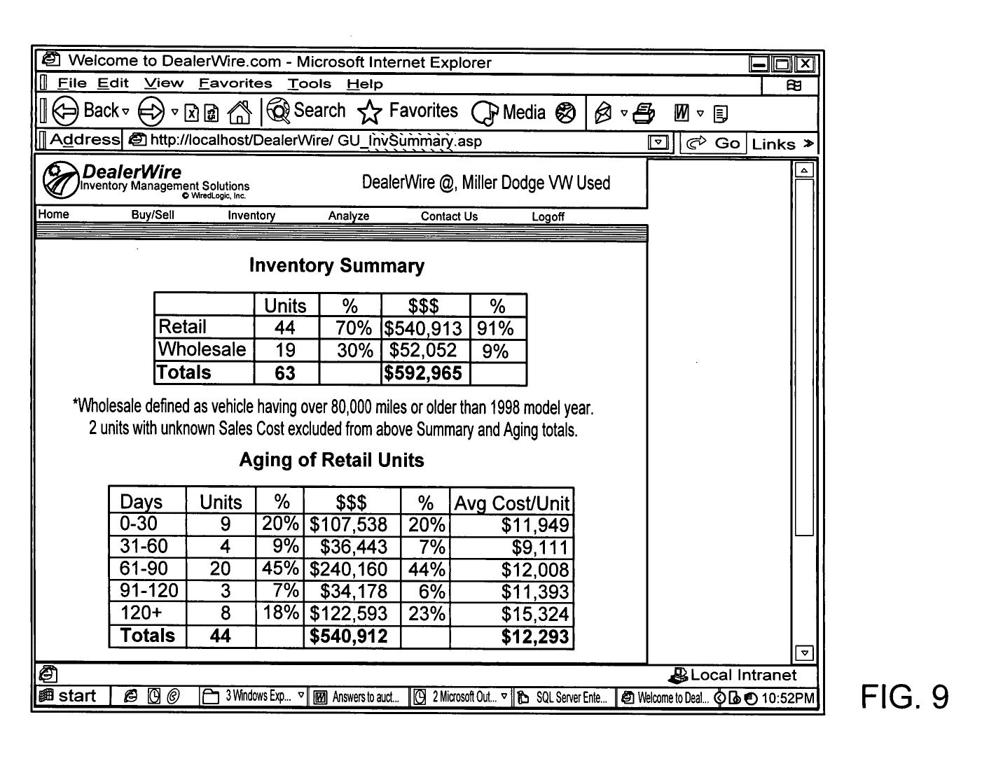

When the user selects the Inventory Summary function on the home page, the IMS application generates a page such as is shown in FIG. 9. This page provides a high level view of inventory mix and aging. Through it the IMS application presents an Inventory Summary showing how the dealer's inventory is distributed among retail and wholesale vehicles by unit count, dollar volume and percentages for both. It also presents an aging table that shows the distribution of retail units according to how many days those units have been in the inventory. Members use this page to get an idea of overall inventory aging and trouble areas, as well as a short buy and sell list. Inventory values are totaled, within sub categories for comparison. Averages are displayed for judging relative problems.

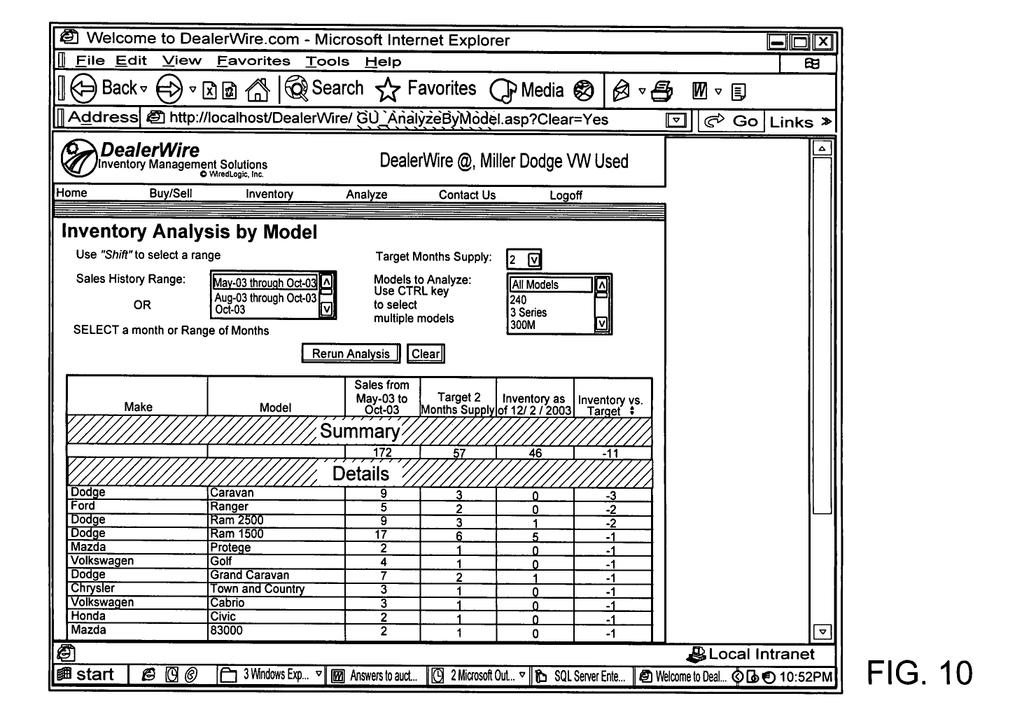

When the user selects the Analyze by Model function on the home page, the IMS application generates a page such as is shown in FIG. 10. The report on this page compares current used inventory with retail sales history for different models. The user chooses a date range, and the report generated by the IMS application compares the retail sales during that date range with current inventory. The report also reports what a target two month's supply should be based on past sales, it reports the present inventory amounts, and it reports the amount by which present inventory either exceeds or falls below the target amounts. So, it is an effective tool to use when developing inventory stocking objectives. In addition, the IMS application will display sales results (customer, sales cost, age of vehicle) for specific transactions in response to the user clicking on the corresponding number in the sales column.

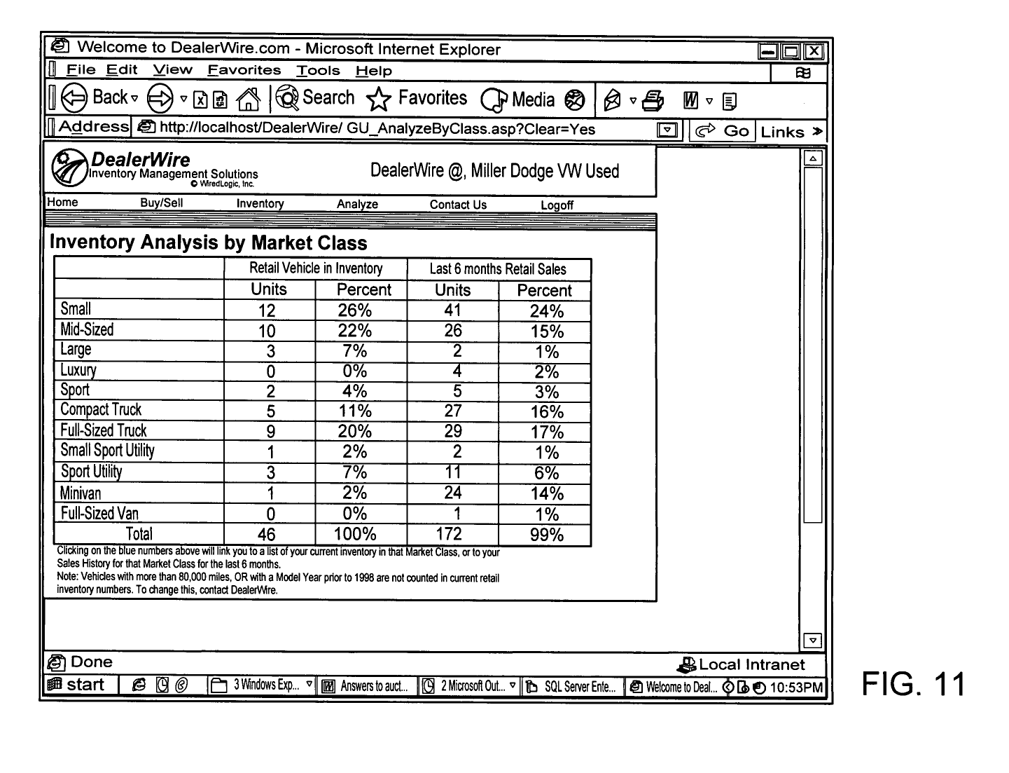

When the user selects the Analyze by Market Class function on the home page, the IMS application generates a page such as is shown in FIG. 11. The report on this page compares current inventory levels to past 6 months sales history to determine stocking levels by market class. Market class is an industry term that is used for categorizing vehicles (e.g. sub-compact, compact, luxury, sport utility, etc. are market classes). This report compares current used “retail” inventory with retail sales history, by both units and percentage. From this screen, the user can link to details about current or historical inventory or sales information by clicking on the appropriate numbers in the units columns.

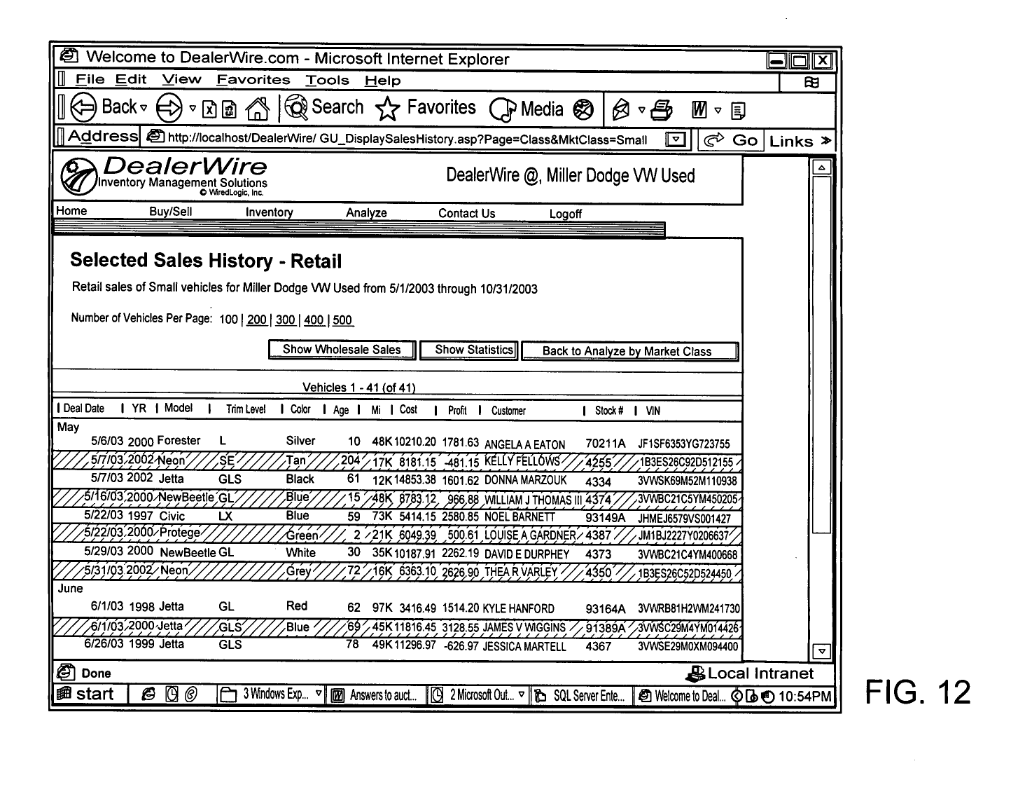

An example of the sales history report that the IMS application generates when the user clicks on the appropriate location in the Inventory Analysis by Market Class screen is shown in FIG. 12. It presents sales history information (see FIG. 12 for details) for the selected market class organized by month. The sales history display allows the user to see individual sales records, with deal date, year, model, trim level, color, age at time of sale, mileage at time of sale, cost, profit, customer name, stock# and VIN. The IMS application allows the user to sort this information to suit the users need.

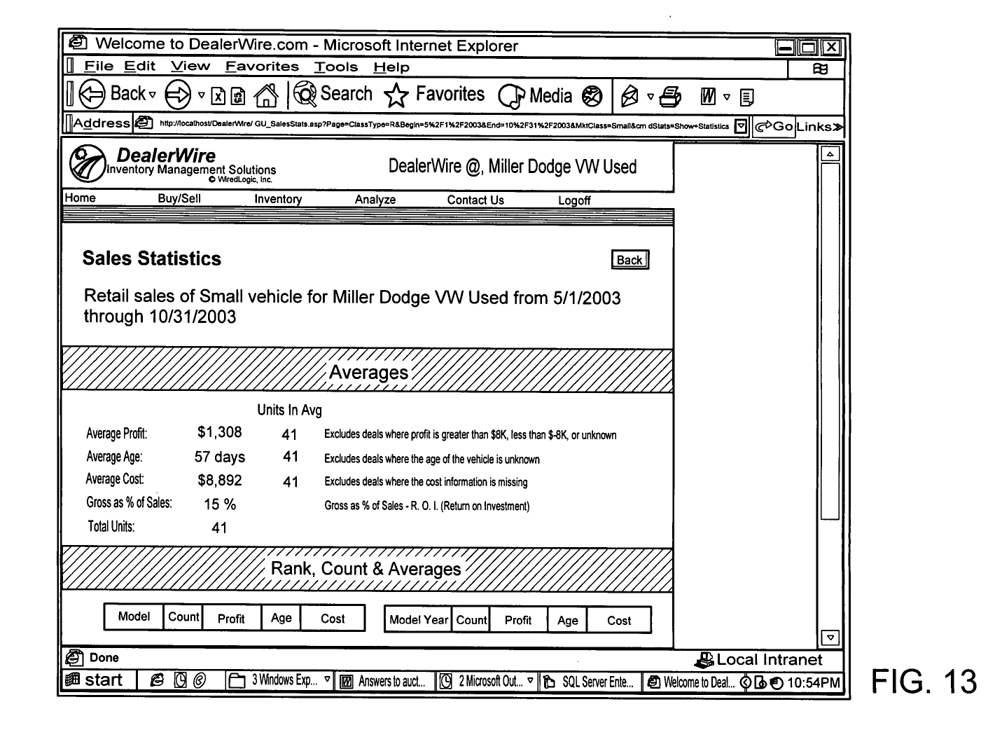

Through the sales history screen, the user can also instruct the IMS application to generate a Sales Statistics screen, and example of which is shown in FIG. 13. The Sales Statistics screen averages and summarizes the information on sales history display. This enables the user to spot trends, both good and bad in a very powerful, and simple to use way.

When the user selects the Analyze by Cost function on the home page, the IMS application generates a page that reports current inventory levels to past 6 months sales history to determine stocking levels by cost range. The report compares current used “retail” inventory with retail sales history, both by units and percentage. From this screen, the user can link to details about current inventory or sales information.

Technology Driven Communication Services:

The IMS application enables members to electronically transmit vehicle data to DealerWire, third party auto auctions houses, or other outside parties, for the purposes of registering a vehicle for auction. This action is simple and requires no incremental key punching of vehicle data. The functionality is integrated into the analysis tools. Thus, a member can use the analysis tools to identify specific vehicles that should be wholesaled (e.g. simply by clicking on the relevant entry), and then electronically register those cars with the designated party.

The IMS application provides dealers with an analytical tool to identify specific vehicles in their inventories that should be wholesaled. By using this tool, dealers can easily register one or more vehicles for sale at the auction of their choice by simply checking a box next to each of those one or more vehicles and then selecting a screen option indicating the user's desire to send the selected vehicles to auction. After the user confirms the selections, accurate vehicle data is then automatically electronically transmitted to the identified third party auction house for all of the selected vehicles. The information that is sent to the auction house includes: VIN, Year, Make, Model, Trim level, color, miles, owning dealer information, asking price, run date, title info (clean, true miles unknown, salvage) (though this could vary depending on the needs of the auction houses).

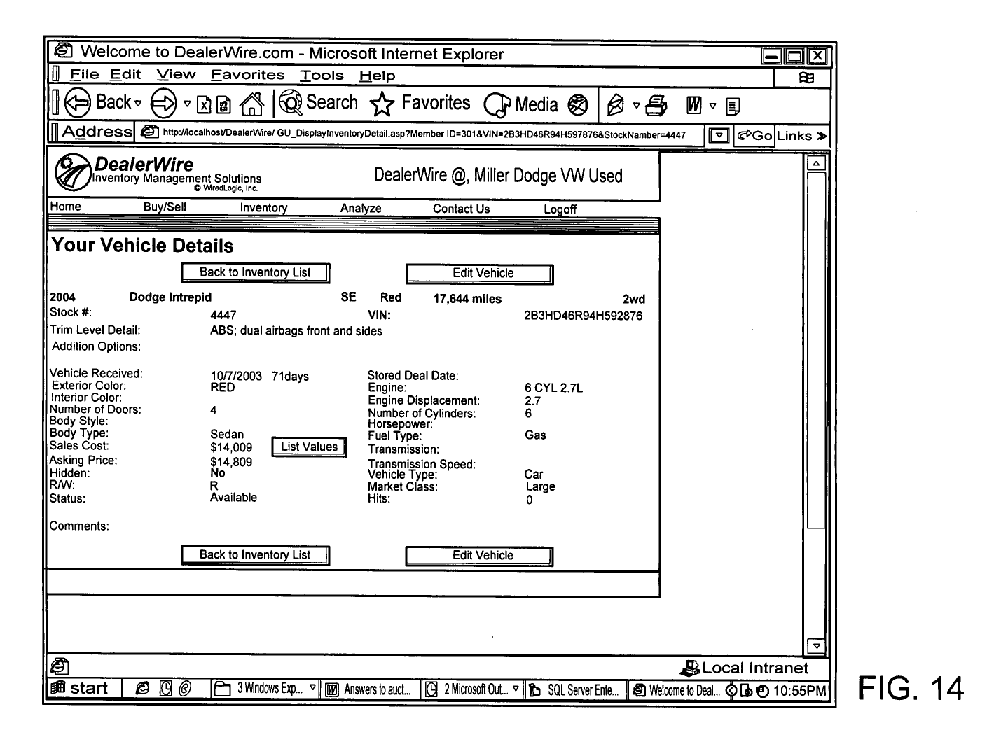

One set of screens that implements this functionality is shown in FIGS. 14-16. From the home screen (FIG. 6), the user can navigate to a Used Inventory screen, such as is shown in FIG. 7. This careen is accessible by selecting List Vehicles in the Home page and then selecting “Used Inventory” in the screen that comes up. The Used Vehicles screen lists all of the used vehicles in that dealer's inventory that might be eligible for wholesale. It also lists specific information for each of the listed vehicles such as Stock No., Year, Make, Model, Trim Level, Color, Age, Mileage, Cost, Asking Price, Hits (i.e., the number of times that other dealers have been notified of that vehicle in their searches) and LD (number of days since last deal). Each entry also includes a “To Auction” check box which enables the user to select that vehicle for electronic enrollment in a third party auction.

From the Used Inventory screen, the user can double click on any listed vehicle to bring up a Vehicle Details screen (see FIG. 14), which presents more information about the selected vehicle.

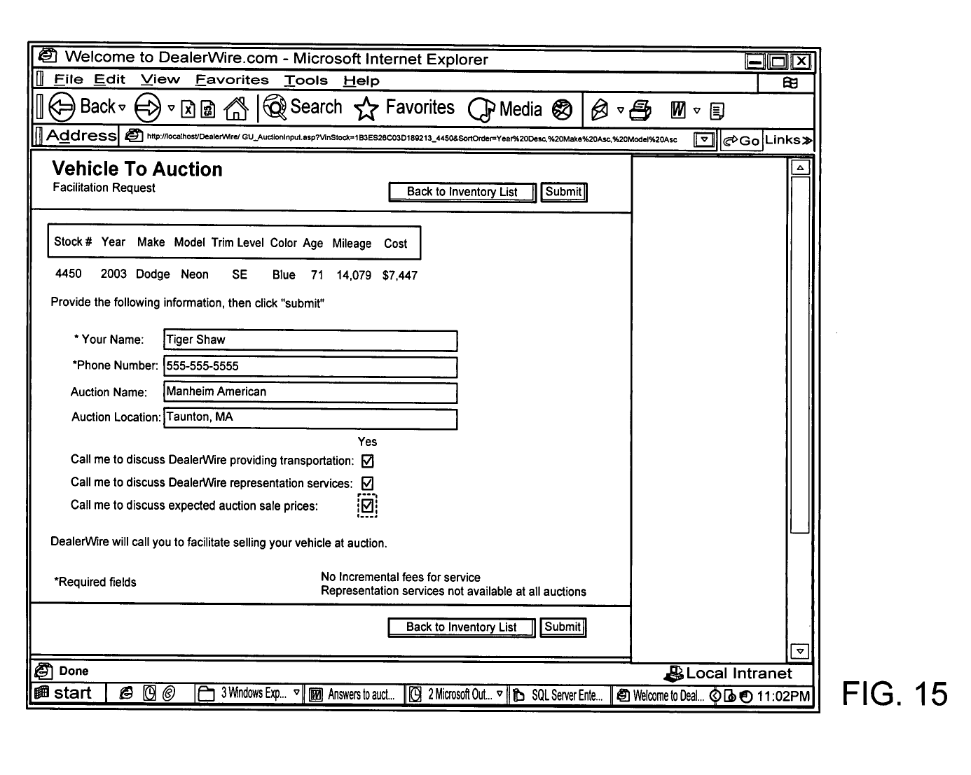

Once the user has identified the vehicles that are to be sent away to auction, the electronic enrollment process can be initiated by selecting the “To Auction” button in the Used Inventory screen (FIG. 7). This causes the IMS application to display through the users browser a Vehicle To Auction screen such as is shown in FIG. 15. This screen automatically lists the vehicles that were checked on the previous screen in the order that they appeared on that screen and without requiring the user to enter any of that data. It also displays the following entry fields, all of which are editable:
1. User Name: (pre-populated based on logged-in user)
2. User Phone Number: (pre-populate based user's main phone number)
3. Auction Name
4. Auction Location

Users are also given the option to check boxes indicating their interest in having DealerWire provide transportation, provide vehicle representation, and/or provide valuation information.

Once the user is satisfied with the information displayed on the Vehicle To Auction screen, clicking the Submit button causes the IMS application to process the Auction request. This involves writing a record to the DealerWire database. The record includes the following information:
RequestDateTime: System date and time request is made
UserNameLoggedIn: User name as it appears in screen
UserNameEntered: User name entered on screen.
PhoneLoggedIn: Phone1 of logged-in member
PhoneEntered: Phone number entered on screen.
AuctionName: Auction name entered on screen.
AuctionLocation: Auction location entered on screen
TransportationFlag: Default 0, 1 if box checked.
RepServicesFlag: Default 0, 1 if box checked.
SalesPriceFlag: Default 0, 1 if box checked.
MemberID: Memberid of owner of vehicles listed
VIN: VIN of vehicle listed (creates one record for each VIN)
StockNumber: Stock # of vehicle
   Clicking the submit button will also generate an email to be sent to DealerWire (or it can be configured to send it directly to the auction house if desired). The “from line” of the email will be populated with the user's email address; the subject line will say “AuctionRequest;” and the body of the email will include the following information:
Date/Time request made:
Vehicle Owner:
Vehicle information
Requesting User:
Phone #:
Auction Name:
Auction Location:
Whether Transportation Assistance is Desired:
Whether Rep Services are Desired:
Whether Sales Price Estimate is Desired:
   The vehicle information includes, ModelYear; Make; Model; TrimLevel; BaseColor; VIN; StockNumber; Mileage; SalesCost; and Vehicle Age. The vehicle information repeats for each vehicle on the same request with a blank line separating each vehicle. In other words, only one email is sent.

Clicking submit also brings the user to an action confirmation screen, which tells the user that they will be contacted by DealerWire (or the party to which the email was sent).

The IMS application's one click vehicle registration service dramatically reduces the logistical complexity of selling cars at auctions held by third party auction houses. All data required for registering a vehicle at an upcoming auction is automatically added to the registration request without requiring any separate user entry. In addition, the analytical tools found in the IMS application enable dealer's to make better decisions on which specific cars they should be wholesaling at the auction. These two benefits make wholesale vehicle selling at auctions easier, more effective and therefore more profitable.

Data Driven Marketing Services:

Data Driven Buyer Solicitation:

The IMS application analyses each dealer's inventory and sales data daily to identify shortages of specific vehicles. Identification of under-stocked status is driven by an automated analysis of current (e.g. prior day) sales and inventory data in conjunction with a dealer's self-defined inventory targets by model. The IMS application matches a dealer's inventory shortages with a list of vehicles that will become available at an upcoming auction. The auction house provides this data electronically to DealerWire. From this matching, the IMS application generates a list of specific vehicles that have been pre-registered at an upcoming auction and that would meet the dealer's inventory needs. Finally, the IMS application communicates the buying opportunity to the dealer in any user-selectable combination of four ways, namely, telephone, e-mail, mail, and fax.

The IMS application includes an automated process that produces individualize marketing materials (e.g. e-mail, direct mail, fax, phone scripts) that present the dealer with current inventory needs and the data that supports the recommendation (e.g. trailing sales by model, trailing average gross by model, training ageing patterns, compared to current inventory).

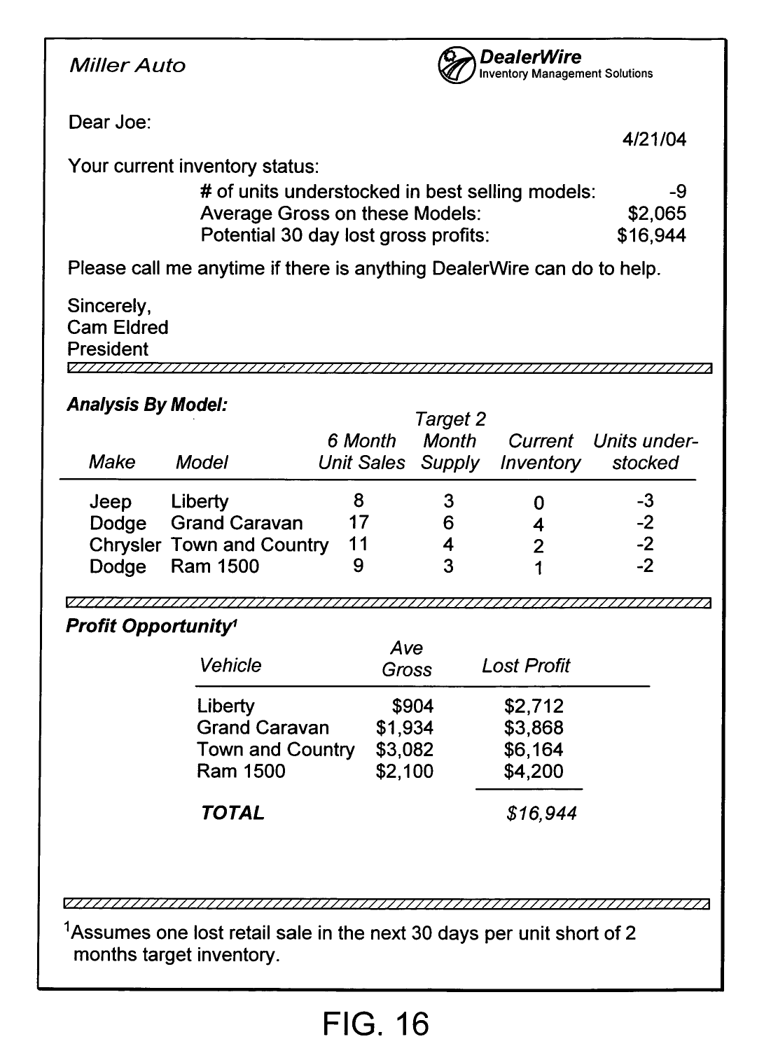

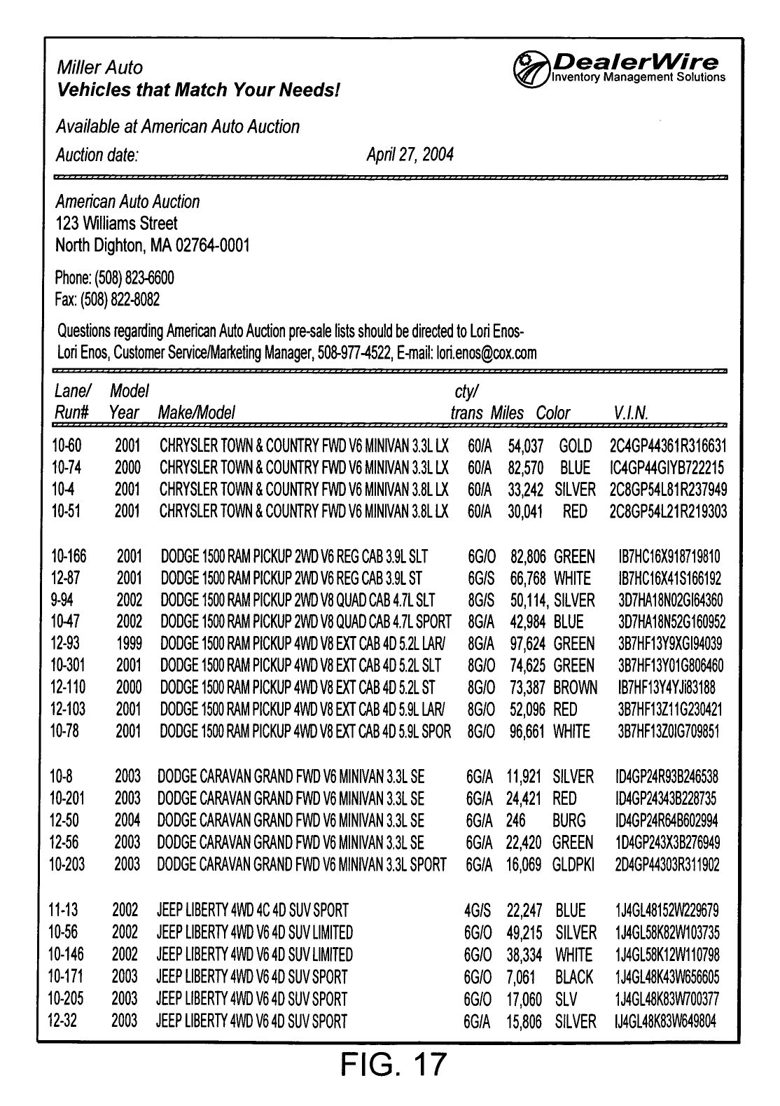

An example of the individualized marketing material that is generated by the IMS application is shown in FIGS. 16 and 17. In this example, the material has two parts. The first part (see FIG. 16) is a letter to the dealer indicating that the dealer's current inventory in his best selling models is under-stocked and it indicates by how much. It also presents the average gross on these models (which is based on dealer sales history) and it presents the potential 30 day lost profits associated with being the under-stocked. The bottom half of the letter provides more details on each of these items. It presents a breakdown of the under-stoked models by identifying make and model; and for each under-stocked make/model vehicle, it presents the dealer's current inventory, the amount by it is under-stocked and the potential lost profit by being under-stocked.

The second art of the marketing material is a list of vehicles that will be presented at an upcoming auction that would address the under-stocked condition of the dealer's present used car inventory. For each vehicle in the list, the document identifies the model year of the vehicle, the precise make and model, the number of cylinder and transmission type, the miles on the vehicle, the color and the VIN. It also identifies the lane and run number in which the vehicle will be shown at the auction.

The IMS application then distributes the individualized marketing pieces either by e-mail, direct mail or fax. In addition, the IMS application has the ability to create call lists that contain the same information. These call lists are used to directly communicate to the dealers.

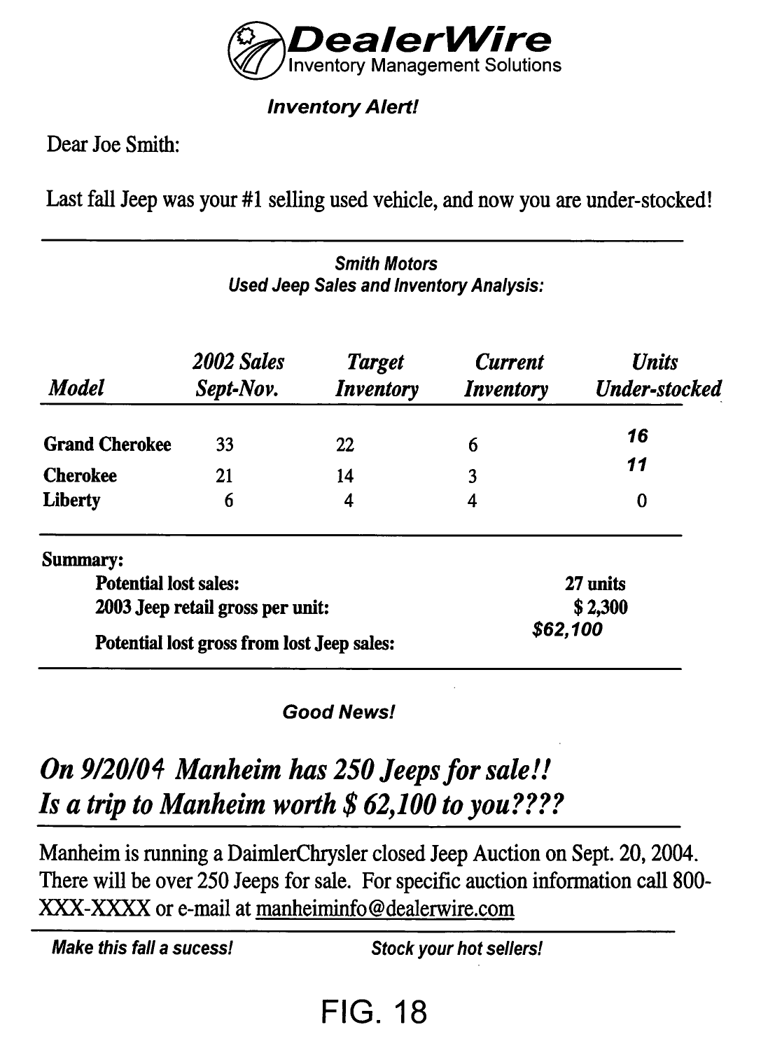

The level of detail that is provided to the dealer can be tailored based on what is deemed to be a more effective marketing approach under the circumstances. FIG. 18 presents an example of a briefer marketing message.

Data Driven Seller Solicitation

The IMS application, through analysis of trailing sales history and inventory, also makes sell recommendations to the dealer. In this case, DealerWire, the auction house, or another third party providing business services to the auction house uses the IMS application to analyze the age of a particular dealer's used car inventory. In the descried embodiment, the IMS application enables the user to identify all vehicles that are in the dealer's inventory that have had zero unit sales over the past six months and to identify all units in the dealer's inventory that are over 90 days old. (Of course, the IMS application allows the user to configure these time periods.)

As in the case of the data driven buyer solicitation, the IMS application can be configured to communicate the selling opportunity to the dealer in any user-selectable combination of four ways, namely, telephone, e-mail, mail, and fax. The IMS application includes an automated process that produces individualize marketing materials (e.g. e-mail, direct mail, fax, phone scripts) that inform the dealer of the old inventory and invites the dealer to send to those vehicles to the third party auction.

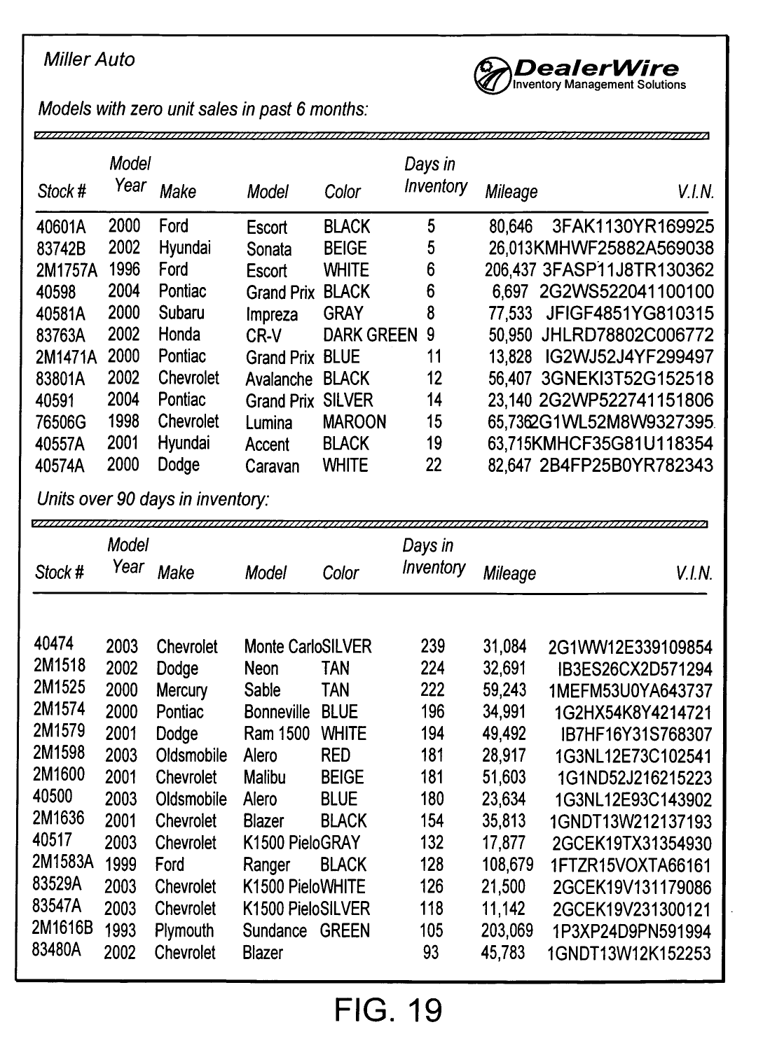

An example of the individualized marketing material that is generated by the IMS application is shown in FIG. 19. It lists “Models with zero unit sales in past 6 months” and “Units over 90 days in inventory.”

If the dealer approves the selling recommendation, he can register the vehicle with an upcoming auction in the manner described earlier, namely, by checking off the appropriate vehicles and hitting the submit button. The IMS application then transfers the vehicle data seamlessly to the auction house electronically.

Needs/Supply Matching Technology

The IMS application also allows the dealer to perform his or her own needs matching. In that case, the dealer uses the browser to instruct the IMS application to cross tabulate vehicles that will be available with actual dealer inventory needs (e.g. based on data driven analysis using the dealer's sales history, gross profit, vehicle characteristics, inventory aging patterns and current inventory). The IMS application then presents the results of the cross tabulation to the user through his browser matching available wholesale inventory with real time inventory needs.

Other embodiments are within the following claims.

1. A computer-implemented method comprising:
obtaining used car inventory and sales history data from a dealer;
obtaining from an auction house a list of auction cars that are being made available through an upcoming auction by the auction house;
analyzing the dealer's used car inventory and sales data to identify one or more categories of cars that are under-stocked;
identifying cars on said list of auction cars that are in the one or more identified categories of under-stocked cars; and
generating a solicitation addressed to said dealer, said solicitation reporting the identified one or more categories of under-stocked cars and reporting the identified cars on the list of auction cars, said solicitation also seeking the dealer's participation in the upcoming auction.

2. The method of claim 1, further comprising sending the solicitation to the dealer.

3. The method of claim 1 wherein obtaining used car inventory and sales history data from a dealer involves electronically polling a dealer inventory management system for that data.

4. A computer-implemented method comprising:
obtaining used car inventory and sales history data from a dealer;
analyzing the dealer's used car inventory and sales data to identify one or more categories of cars that are overstocked;
generating a solicitation addressed to said dealer, said solicitations reporting the identified one or more categories of overstocked cars and seeking the dealer's participation in an upcoming auction.

5. The method of claim 4, further comprising sending the solicitation to the dealer.

6. A method implemented by a facilitator entity for soliciting participation by a used car dealer entity in an upcoming car auction being held by an auction house, the facilitator entity and the dealer entity being separate independent businesses, said method comprising:
obtaining electronically from said car dealer used car inventory and sales history data for cars held by said dealer;
obtaining electronically from the auction house a list of auction cars that are being made available through an upcoming auction;
causing a computer system to analyze the dealer's used car inventory and sales data to identify a category of cars that is under-stocked by said dealer;
causing the computer system to identify cars on said list of auction cars that are in the under-stocked category; and
generating a solicitation addressed to said dealer, said solicitation identifying the dealer's under-stocked category and identifying the cars on the list of auction cars that are in the under-stocked category.

7. The method of claim 6 further comprising including within said solicitation an invitation seeking the dealer's participation in the upcoming auction.

8. The method of claim 6 wherein generating involves causing the computer system to generate the solicitation using data electronically obtained from the car dealer and from the auction house.

9. The method of claim 6 wherein the facilitator entity and the auction house are separate independent business entities.

10. A computer-implemented method comprising:
obtaining electronically data regarding a car dealer's inventory of used cars, said inventory data including year, make, model, and mileage for each car represented in said inventory;
generating a graphical user interface on a computer operated by a user on behalf of the car dealer, said graphical user interface listing used cars within the used car dealer's inventory of used cars, each displayed used car listing including a selection box for enabling a user selecting the vehicle to register with an auction house for auction;
receiving an indication that the user has checked a box for a selected used car among the listing;
in response receiving said indication, requesting confirmation that the user wants the selected used car to be registered with the auction house for an upcoming; and
in response to receiving confirmation from the user, registering the selected with the auction house.
